(19) United States
(12) Patent Application Publication
(10) Pub. No.: US 2024/0393488 A1
(43) Pub. Date: Nov. 28, 2024

(54) SEISMIC FEATURE DETECTION USING DENOISING DIFFUSION PROBABILISTIC MODEL

(71) Applicant: SAUDI ARABIAN OIL COMPANY, Dhahran (SA)

(72) Inventors: Bingbing Sun, Dhahran (SA); Robert James Smith, Dhahran (SA); Abdulmohsen M. Ali, Dammam (SA); Nasher M. Albinhassan, Dammam (SA)

(73) Assignee: SAUDI ARABIAN OIL COMPANY, Dhahran (SA)

(21) Appl. No.: 18/324,927

(22) Filed: May 26, 2023

(51) Int. Cl. G01V 1/30; E21B 49/00

(52) U.S. Cl. CPC G01V 1/30; E21B 49/00; G01V 1/282; G01V 2210/642

(57) ABSTRACT

A method and system for identifying a feature in seismic datasets using a machine learning (ML) network is provided. The method includes training the ML network by obtaining a seismic dataset and forming a plurality of seismic patches having a labeled feature. Training the ML network continues by predicting a candidate labeled feature patch for each seismic patch, forming a metric measuring a mismatch of the candidate labeled feature patch and the labeled feature and updating the ML network based on finding an extremum of the mismatch to form a trained ML network. The method further includes forming a plurality of production seismic patches having unlabeled features and inputting the patches into a trained ML network to predict a labeled feature patch having a labeled manifestation of the feature. A predicted labeled feature image may then be formed by merging the plurality of predicted labeled feature patches.

### BACKGROUND

In the oil and gas industry, a seismic image of a subterranean region of interest may be used to identify the location and size of structural features within the subterranean region of interest. Structural features include interfaces between layers of rock (“horizons”) and faults. The identification of these structural features plays an important role in hydrocarbon reservoir characterization and well placement. Current methods used to identify structural features within the subterranean region of interest may include the interpretation of computed seismic attributes using mathematical models, which may require significant user interaction. Further, current methods may not incorporate prior geological information of the fault structure or allow an uncertainty analysis to be performed.

Following the proper identification of structural features within the subterranean region of interest, the structural features may be used, at least in part, to inform a geological model of and/or identify a drilling target within a hydrocarbon reservoir within the subterranean region of interest.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relating to a method for identifying a feature in seismic datasets using a machine learning (ML) network is provided. The method includes training the ML network by obtaining a seismic dataset and forming a plurality of seismic patches having a labeled feature. Training the ML network continues by predicting a candidate labeled feature patch for each seismic patch, forming a metric measuring a mismatch of the candidate labeled feature patch and the labeled feature and updating the ML network based on finding an extremum of the mismatch to form a trained ML network. The method further includes forming a plurality of production seismic patches having unlabeled features and inputting the patches into a trained ML network to predict a labeled feature patch having a labeled manifestation of the feature. A predicted labeled feature image may then be formed by merging the plurality of predicted labeled feature patches.

In general, in one aspect, embodiments relate to a system that includes a seismic acquisition system, a seismic processing system and a trained ML network is provided. The seismic acquisition system is configured to obtain a production seismic dataset over a subterranean region of interest and the seismic processing system is configured to receive the production dataset and form a plurality of production seismic patches. The trained ML network including a diffusion probabilistic model, is configured to receive each production seismic patch and create a predicted labeled feature image. The diffusion probabilistic model may include a denoising diffusion probabilistic model. The predicted labeled feature image includes a labeled manifestation of the feature, and the feature may include a fault. The system further includes a seismic interpretation workstation configured to identify a drilling target within the subterranean region of interest based on the predicted labeled feature image, a wellbore planning system configured to plan a wellbore path based on the drilling target and a drilling system configured to drill a wellbore guided by the wellbore path.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a seismic survey in accordance with one or more embodiments.

FIG. 2 displays a seismic image in accordance with one or more embodiments.

FIG. 3A illustrates a forward diffusion process in accordance with one or more embodiments.

FIG. 3B illustrates a reverse diffusion process in accordance with one or more embodiments.

FIG. 4 illustrates a neural network in accordance with one or more embodiments.

FIGS. 5A-5F illustrates a series of predicted labeled feature patches in accordance with one or more embodiments.

FIGS. 6A-6D illustrate outputs from a trained ML network in accordance with one or more embodiments.

FIG. 7 describes a method in accordance with one or more embodiments.

FIG. 8 describes a method in accordance with one or more embodiments.

FIG. 9 illustrates a drilling system in accordance with one or more embodiments.

FIG. 10 illustrates a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a window” includes reference to one or more of such windows.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

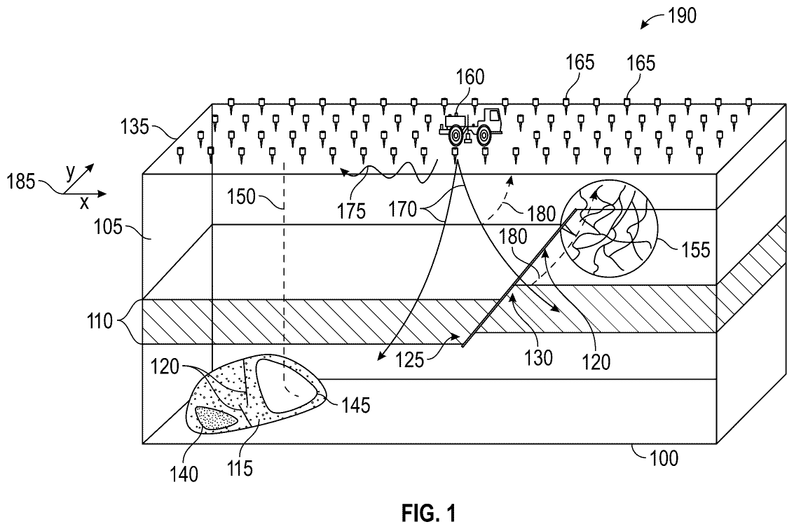

In the following description of FIGS. 1-10, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Methods and systems are disclosed to determine a predicted labeled feature image from geological data. The methods include both training a ML network to form a trained ML network and using the trained ML network to label a feature within geologic data. The geological data may include a seismic image and the features may include faults or horizons. Training the ML network includes splitting a seismic dataset into a plurality of seismic patches to input into the ML network. The ML network includes a diffusion probabilistic model (DPM) and more specifically a denoising diffusion probabilistic model (DDPM). The ML network, during the training, predicts a candidate labeled feature patch from an input seismic patch. The candidate labeled feature patch includes a binary image where each pixel is labeled as being intersected by a fault, or not being intersected by a fault. A metric is formed that measures the mismatch of the candidate labeled feature patch and the labeled features from the input seismic patch and the DDPM is updated based on finding an extremum of the metric. The DDPM is updated based on the update forming a trained ML network.

The method continues by determining a predicted labeled feature image from a production seismic dataset based, at least in part, on using the trained ML network. The production seismic dataset includes unlabeled structural features and is split into a plurality of production seismic patches containing overlap to be input into the trained ML network. For each seismic patch, a predicted labeled feature patch is predicted and includes a labeled manifestation of the feature. The predicted labeled feature image is determined by merging the overlap of each predicted labeled feature patch.

The present disclosure may be an improvement over current methods used to identify a manifestation of a structural feature within a seismic image. Current methods may rely on an interpreter to manually identify the manifestation of the structural feature within the seismic image. Other current methods may include determining a value of a seismic attribute at each position within the seismic image and applying a threshold to the values to locate the manifestation of the structural feature. Seismic attributes may include, but are not limited to, semblance, coherence, variance, and curvature. Still other current methods may include applying a mathematical model to the seismic image to locate the manifestation of the structural feature. Current methods exhibit two major limitations which includes the inability to incorporate geological prior information into ML networks and the inability to perform uncertainty analysis on the predictions. However, the present disclosure may use a supervised classification by training the ML network on labeled input seismic patches. Furthermore, the present disclosure may use a stochastic process, which, in turn, may be used to perform an uncertainty analysis, increasing the confidence of the predicted features.

FIG. 1 illustrates a subterranean region of interest (100) in accordance with one or more embodiments. The subterranean region of interest (100) may be made up of layers of rock (105) separated by geological boundaries often denoted horizons (110). The subterranean region of interest (100) may contain a hydrocarbon reservoir (115). The hydrocarbon reservoir (115) may be rock (105) filled with fluid such as oil, gas, water, brine, and/or a combination thereof. The rock (105) and the hydrocarbon reservoir (115) within the subterranean region of interest (100) may include one or more faults (120). A fault (120) may be identified as a break or discontinuity within a volume rock (105) where the rock (105) becomes displaced to one side of the break (i.e., a fault block) and a fault plane describes the fracture surface of the fault (120). In some cases, the fault block above the fault (120) may be denoted as the hanging wall (125). The fault block below the fault (120) may then be denoted the footwall (130).

Faults (120) may be classified in terms of the direction of slip along the fault plane. General types of faults (120) include, but are not limited to, normal, reverse, and strike-slip. In a normal fault, as shown in FIG. 1, the hanging wall (125) may slip downward relative to the footwall (130) due to tensile force. In a reverse fault, the hanging wall (125) may slip upward relative to the footwall (130) due to compressive force. In a strike-slip fault, the fault blocks may slip parallel to the fault plane due to shear stress. Note that the present disclosure should in no way be limited based on the type, sub-type, orientation, or any other characteristic associated with a fault (120) or associated with any other structural feature. Another structural feature within the subterranean region of interest (100) is a weakness zone (155). Weakness zones (155) describe an area within a rock (105) formation that exhibits significantly poorer rock mass properties compared to the surrounding rock (105) within the formation. Weakness zones (155) may include, but are not limited to fault zones, shear zones, thrust zones, or brittle rock or mineral layers. Hereinafter, “structural features” or simply “features” within the subterranean region of interest (100) may include, but are not limited to, horizons (110), faults (120), weakness zones (155) and hydrocarbon reservoirs (115).

Faults (120) within the hydrocarbon reservoir (115) may control, at least in part, the vertical and lateral distribution of hydrocarbons by creating compartments (140) within the hydrocarbon reservoir (115). Because some faults (120) may leak, seal, or both leak and seal hydrocarbons over time, some compartments (140) may often not contain hydrocarbons while other compartments (140) may often contain hydrocarbons. The faults (120) may also be conduits for which hydrocarbons flow. As such, it may be useful to identify the location of the faults (120) within the subterranean region of interest (100). In turn, compartments (140) that often contain hydrocarbons may be identified as a drilling target (145) using, at least in part, the identified locations of the faults (120). The size of the compartment (140) identified as the drilling target (145) may also be determined using, at least in part, the identified locations of the faults (120). A wellbore path (150) may then be planned to intersect the drilling target (145) while also avoiding the faults (120) as the faults (120) may be considered drilling hazards.

A seismic survey of the subterranean region of interest (100) may be used, at least in part, to identify the location and size of faults (120), and other features like horizons (110), within the subterranean region of interest (100). FIG. 1 further illustrates a seismic survey in accordance with one or more embodiments. The seismic survey may be performed using a seismic acquisition system (190). The seismic acquisition system (190) may include a seismic source (160) and seismic receivers (165) positioned on the surface of the earth (135).

The seismic survey may utilize the seismic source (160) that is configured to generate radiated seismic waves (170) (i.e., emitted energy, wavefield). The type of seismic source (160) may depend on the environment in which it is used. For example, on land, the seismic source (160) may be a vibroseis truck or an explosive charge. In water, the seismic source (160) may be an airgun. The radiated seismic waves (170) may return to the surface of the earth (135) as refracted seismic waves (not shown) or may be reflected by horizons (110) and return to the surface of the earth (135) as reflected seismic waves (180). The radiated seismic waves (170) may also propagate along the surface as Rayleigh waves or Love waves, collectively known as “ground roll” (175). Vibrations associated with ground roll (175) do not penetrate far beneath the surface of the earth (135) and, hence, are not influenced by, nor contain information about, portions of the subterranean region of interest (100) where hydrocarbon reservoirs (115) typically reside. Seismic receivers (165) located on or near the surface of the earth (135) are configured to detect reflected seismic waves (180), refracted seismic waves, and ground roll (175).

Assume the position of the seismic source (160) is denoted (xₛ,yₛ) and the position of each seismic receiver (165) is denoted (xᵣ,yᵣ), where x and y represent orthogonal axes (185) on the surface of the earth (135) above the subterranean region of interest (100). The seismic trace, or time-series data, recorded by each seismic receiver (165) may then be denoted S(xₛ,yₛ,xᵣ,yᵣ,t) and described as seismic data.

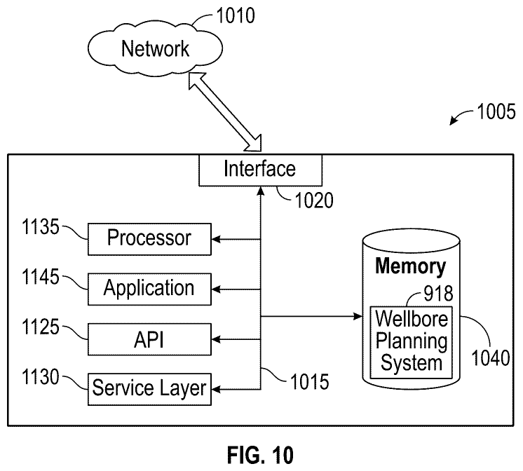

The seismic data may be processed using a seismic processing system, which will be discussed in reference to FIG. 10, to ultimately determine a seismic image. The seismic data may be processed by methods that include migration, stacking, and filtering to produce seismic traces with a high signal-to-noise ratio. The horizons (110) may manifest as large amplitudes within the seismic image. Faults (120) may manifest as discontinuities within the seismic image. How a feature manifests within a seismic image, or other geological data, should in no way limit the scope of the disclosure.

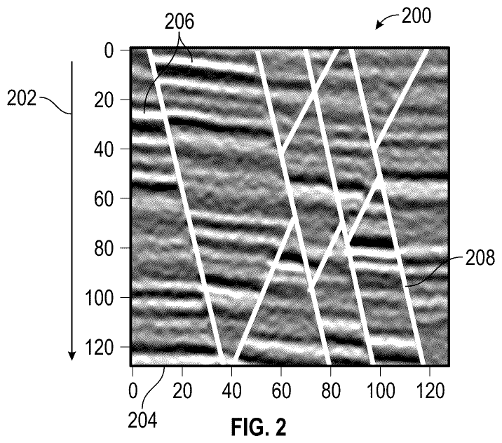

FIG. 2 displays a seismic image (200) in accordance with one or more embodiments. The seismic image (200) may show seismic reflections (206) at increasing depths or two-way travel times indicated by the vertical axis (202). The horizontal axis (204) represents the horizontal locations of these seismic reflections (206). These seismic reflections (206) indicate a property change between two layers within the subsurface, including changes in lithology or fluids present. The seismic image (200) may also include a labeled feature (208) in accordance with one or more embodiments including faults (120). Features may be labeled within a seismic dataset using trace headers, which acts as a seismic database that stores information about each pixel within the seismic image (200). Certain features for each pixel may be given a binary value to indicate the presence or absence of a certain feature. In FIG. 2, the labeled features (208) are faults (120) shown in white lines that displace these seismic reflectors (206) relative to one side of the fault (120). While FIG. 2 displays a two-dimensional seismic image (200), the seismic image (200) may be any higher dimensionality without departing from the scope of the disclosure.

Identifying faults (120) within a seismic dataset plays an important role in reservoir characterization and well placement. The conventional methods for fault (120) identification rely on the generation of attributes from the seismic datasets including coherency, semblance, and variance. Generating these attributes may be labor intensive and time consuming particularly for large complex seismic volumes. Furthermore, these additional attribute datasets require significant amounts of computational resources and memory. These attributes are typically interpreted by a person skilled in the art to label the feature. This conventional feature identification technique introduces an element of bias based on the skilled person's expertise and knowledge of the subterranean region of interest (100). Utilizing machine learning (ML) techniques to identify a feature within a seismic dataset is a rapidly-expanding technique used to replace these traditional techniques. The standard ML techniques being used often experience limitations however, including the inability to perform an uncertainty analysis on the predicted features and being unable to incorporate geological prior information into the ML networks. A method, such as the method disclosed herein, to identify features within a seismic dataset that addresses these limitations would improve upon the existing ML techniques and increase the confidence in the predicted features by performing an uncertainty analysis.

While a seismic image, such as seismic image (200), may display a labeled feature (208), other data may also display the labeled feature (208). Other data may include, but are not limited to, well logs, a seismic velocity model (hereinafter also “velocity model”), a seismic attribute dataset and facies information. Hereinafter, “geological data” may include only a seismic image, such as seismic image (200), or geological data may include a seismic image, such as seismic image (200), and any other data, such as those previously listed, pertaining to the subterranean region of interest (100).

Turning to the other geological data, the velocity model may be determined from a seismic survey, a vertical seismic profile (VSP) survey, and/or a checkshot survey. Further, the facies information may be determined from outcrops and/or rock cores. Similar to the well logs, the velocity model and/or the facies information may display labeled features (208).

In some embodiments, a seismic dataset may include large amounts of data and processing the dataset may be computationally intensive and time-consuming. Therefore, seismic datasets are typically broken down into smaller sections for processing and interpretation. Seismic datasets comprising many seismic images (200) may be separated into smaller 1-D seismic patches using a seismic processing system. A seismic patch may be created by partitioning the seismic dataset into smaller sections by performing a sorting or selection process. The sorting process may separate one seismic image (200) from another based on a two- or three-dimensional grid. For example, a seismic dataset may be separated into a plurality of 1-D seismic patches based on a spatial location on the grid. A seismic image (200) may be separated by each inline, which represents a row on the grid describing the direction of seismic data collection, or by each crossline, which represents the direction parallel to the seismic acquisition. Seismic datasets may be partitioned into seismic patches based on other criteria and any type of seismic patches may be created using the method described herein. While the seismic patches illustrated in this disclosure are shown as 1-D, the seismic patches may also be any higher dimensionality without departing from the scope of the disclosure.

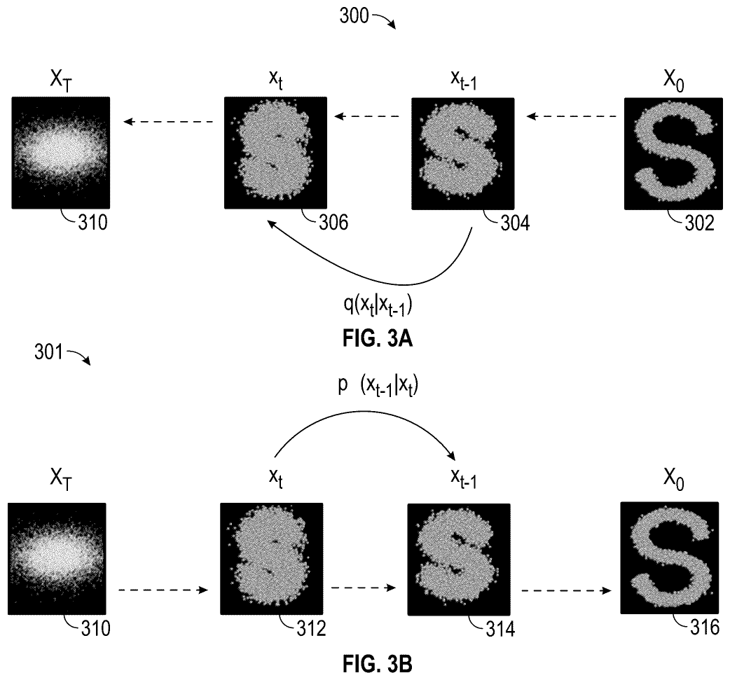

FIGS. 3A and 3B illustrate a forward diffusion process (300) and a reverse diffusion process (301) of a ML network in accordance with one or more embodiments. The ML network may include a diffusion probabilistic model (DPM). Seismic patches (302) having a labeled feature (208) may be used to train the DPM to label the feature in accordance with one or more embodiments. By using features that are labeled within the inputs to the model, the DPM may be considered a supervised classification model. The DPM model may generate a candidate labeled feature patch (316), which includes a seismic patch with predicted labeled features. In some embodiments the candidate labeled feature patch (316) may be a binary image, having pixels being labeled as a predicted label feature or not a predicted labeled feature. In other embodiments, the candidate labeled feature patch (316) may be a seismic image (200) having the predicted labeled feature information included in the seismic header information. This candidate labeled feature patch (316) may be compared to the original seismic patch (302), to form a metric measuring the mismatch of the labeled features (208) and the predicted labeled features. The DPM may be updated based on finding an extremum of the metric and a trained DPM may be formed based, at least in part, on the update.

Using a DPM for feature detection addresses two major limitations of using more traditional ML techniques to predict features in seismic data which are the inability to incorporate geologic prior information into the ML network and an inability to perform an uncertainty analysis of the detected features. The DPM incorporates prior geologic information from the labeled input seismic patches (302) which reduces any bias from a seismic interpreter's knowledge and expertise leading to a more robust prediction. Also, due to the probabilistic nature of a DPM, an uncertainty analysis may be performed on the predicted features by running predictions and analyzing its statistics including mean and variance.

The process begins by training the DPM on seismic patches (302) having a labeled feature (208) from a training dataset. The DPM may be a denoising diffusion probabilistic model (DDPM). A DDPM is a generative model used in ML techniques for image or signal processing. A DDPM may be parameterized by the Markov chain using variational inference (VI) and may include a forward diffusion process (300) and reverse diffusion process (301). A Markov chain is a stochastic model that describes a sequence of possible events in which the probability of each event is only dependent on the state attained in the previous event. These probabilities, or probability distributions may be approximated using VI so that they resemble the target distribution or the variable the DDPM is attempting to predict. The method to train the DDPM is given in more detail in the following sections.

In the forward diffusion process (300), the DDPM accepts a seismic patch (302) or x₀, having a labeled feature (208) and generates a random noise patch (310) xₜ, by adding a random noise to the seismic patch (302) iteratively until the image becomes fully random with noise. In FIG. 3A, a random noise is added to the seismic patch (302) to create a first noise patch (304) and an additional iteration of random noise is added to the first noise patch (304) to generate the second noise patch (306). The probability distribution of going from the first noise patch (304) to the second noise patch (306) is defined as q(xₜ₋₁|xₜ). Additional iterations of random noise addition may be performed until the image becomes fully random with noise, referred to as a random noise patch (310). In some embodiments the random noise may be a Gaussian noise. The DDPM learns the probability distributions of moving to each subsequent state in the forward diffusion process (300). The forward diffusion process (300) may be mathematically expressed as:

$$q ( {x}_{1 : T} \vert {x}_{0} ) = {\prod }_{t = 1}^{T} q ( {x}_{t} \vert {x}_{t - 1} ) = {\prod }_{t = 1}^{T} N ( {x}_{t} ; \sqrt{1 - {β}_{t}} {x}_{t - 1} , {β}_{t} I ) \qquad Equation ( 1 )$$

where parameter βₜ defines the noise schedule, chosen such that q(x_{T}|x₀)≈N(0,I) and T is the total number of iteration steps. In this forward process, a Gaussian noise is added to the input seismic patch (302), until the random noise patch (310) is fully random with a Gaussian distribution x_{T}˜N(0,I). In the forward diffusion process, the noise schedule βₜ is specified and remains fixed during the training of the ML network for a reverse diffusion process (301).

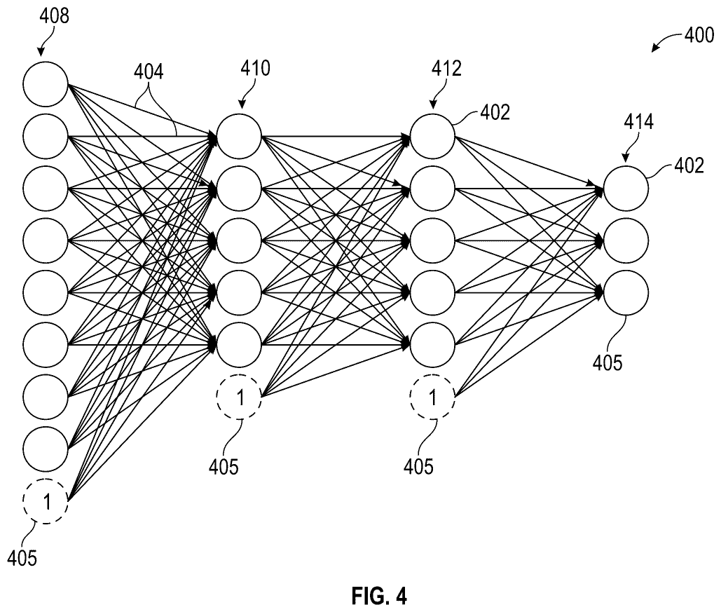

In the reverse diffusion process (301), a neural network may be trained to generate data by converting the fully random noise patch (310) into realistic data, or denoising the random noise patch (310) until it resembles the original input seismic patch (302). Neural networks will be described in more detail in FIG. 4. The reverse diffusion process (301) begins with pure Gaussian noise p(x_{T})=N(x_{T};0,I), and DDPM learns the joint distribution p_{θ}(x_{0:T}) as:

$${p}_{θ} ( {x}_{0 : T} ) = p ( {x}_{T} ) {\prod }_{t = 1}^{T} {p}_{θ} ( {x}_{t - 1} \vert {x}_{t} ) = p ( {x}_{T} ) {\prod }_{t = 1}^{T} N ( {x}_{t - 1} ; {μ}_{θ} ( {x}_{t} , t ) , {Σ}_{θ} ( {x}_{t} , t ) ) \qquad Equation ( 2 )$$

where θ is the parameters of the neural network for the Gaussian transformation N. The reverse diffusion process (301) may generate a best fit of the added noise e in the form of a loss function.

Shown in FIG. 3B, the random noise patch (310) is denoised in the reverse diffusion process (301) to create a first denoised patch (312) and denoised once again to create a second denoised patch (314). The probability distribution of going from the first denoised patch (312) to the second denoised patch (314) is defined as p_{θ}(xₜ₋₁|xₜ) and may be solved by generating a loss function to fit the previously added noise. While the probability distribution q(xₜ₋₁|xₜ) is given manually in the forward diffusion process, the probability distribution for the reverse process, p_{θ}(xₜ₋₁|xₜ) is represented by a neural network. The loss function may quantify of the differences between the two probability distributions, such as q(xₜ₋₁|xₜ) and p_{θ}(xₜ₋₁|xₜ).

The loss function may be based, at least in part, on a Kullback-Leibler (KL) divergence in accordance with one or more embodiments. In these embodiments the KL divergence may be used to quantify the difference between the two probability distributions of the forward diffusion process (300) and the reverse diffusion process (301). The DDPM considers the added noise as an independent parameter and trains only the mean μ_{θ}(xₜ,t) in Equation (2). This simplification leads to a more stable loss function for fitting the random noise patch (310) and Equation (3) may be derived by a KL divergence between Equations (1) and (2), given as:

$$L = {\sum }_{t} {‖ ϵ - {ϵ}_{θ} ( \sqrt{{\overline{α}}_{t}} {x}_{0} + \sqrt{1 - {\overline{α}}_{t}} ϵ , t ) ‖}^{2} \qquad Equation ( 3 )$$

where αₜ=1−βₜ and α̅ₜ=Πᵢ₌₁^{T}αᵢ. A U-Net architecture is used here with self-attention for the neural network ∈_{θ}. Intuitively, the reverse diffusion process (301) may eventually predict a candidate labeled feature patch (316) resembling the original seismic patch (302).

Feature detection using a DDPM may be formulated as conditional generation naturally. In other words, this ML task may be framed as a conditional generation problem without the need for complex transformations or additional assumptions because the input and output data are directly related. By denoting the feature as x₀ and the input seismic patch (302) as c₁, the diffusion process may be conditioned for feature detection specifically. This may require a modification to a neural network from ∈(\sqrt{α̅ₜ}x₀+\sqrt{1−α̅ₜ}∈,t) to ∈_{θ}(\sqrt{αₜ}x₀+\sqrt{1−α̅ₜ}∈,c₁,t) in Equation (3), which finally leads to the following loss function that may be used for feature detection:

$$L = {\sum }_{t} {‖ ϵ - {ϵ}_{θ} ( \sqrt{{\overline{α}}_{t}} {x}_{0} + \sqrt{1 - {\overline{α}}_{t}} ϵ , {c}_{I} , t ) ‖}^{2} \qquad Equation ( 4 )$$

In the above implementation, c₁ is added as an extra channel of the U-Net input. Alternatively, in some embodiments, the seismic patch (312) c₁ may be passed through several CNN layers and then the resulting features are added to the input of \sqrt{α̅ₜ}x₀+\sqrt{1−α̅ₜ}∈, similarly to position encoding in a transformer (Ashish et al., 2017).

While the examples provided herein describe 2D results only, the method may also be performed using 3D or higher dimensional datasets. The application of a 3D dataset is straightforward and only the corresponding U-Net needs to be modified to accommodate a 3D convolutional neural network (rather than 2D).

In some embodiments, a seismic patch (302) having a labeled feature (208) may be compared to the candidate labeled feature patch (316) generated from the DDPM. A metric measuring the mismatch between the labeled features (208) of the seismic patch (302) and the predicted features of candidate labeled feature patch (316) may be formed. The metric may be a predefined accuracy metric that gives an allowable mismatch criterion for a successful prediction. In some embodiments, this metric may be formed by performing an uncertainty analysis, including generating a variance map. Variance maps are generated to visualize and quantify the spatial variability or uncertainty in a dataset. Other methods of performing an uncertainty analysis may be performed and include Monte Carlo simulations, correlation coefficient analysis, root-mean-square-deviations (RMSD) and error propagations. A mismatch metric may be based, at least in part, on the uncertainty analysis results. In some embodiments, the metric may be measured by a benchmark percentage of pixels having features successfully identified. After the creation of each candidate labeled feature patch (316), this metric is formed and the DDPM may be updated based, at least in part, on finding an extremum of the metric. In other words, the DDPM will determine the input parameters of the model that would minimize the mismatch between the labeled features (208) and the predicted features and subsequently update the DDPM to incorporate the new parameters.

The DDPM described above may be trained on several seismic patches (302) from a training dataset. The training dataset may also include several separate seismic datasets from multiple regions, each having unique feature characteristics that are labeled in the inputs. The DDPM may be sufficiently trained when the model parameters converge to a solution or the uncertainty analysis consistently meets an approved acceptance criterion. Once the DDPM has been sufficiently trained using multiple seismic patches (302) from multiple training datasets it may be used on an unlabeled seismic dataset from a production seismic dataset to find and label features automatically.

Previously mentioned, a type of ML network, such as a neural network may be trained for the reverse diffusion process (301). In some embodiments, the ML model may be a recurrent convolutional neural network (RCNN), such as the Pixel convolutional neural network (PixelCNN). An RCNN may be more readily understood as a specialized neural network and, from there, as a specialized convolutional neural network (CNN). Thus, a cursory introduction to a neural network and a CNN are provided herein. However, note that many variations of a neural network and CNN may exist. Therefore, one of ordinary skill in the art will recognize that any variation of a neural network or CNN (or any other ML model) may be employed without departing from the scope of this disclosure. Further, it is emphasized that the following discussions of a neural network and CNN are basic summaries and should not be considered limiting.

A diagram of a neural network (400) is shown in FIG. 4. At a high level, a neural network (400) may be graphically depicted as being composed of nodes (402) and edges (404). The nodes (402) may be grouped to form layers (405). FIG. 4 displays four layers (408), (410), (412), (414) of nodes (402) where the nodes (402) are grouped into columns. However, each group need not be as shown in FIG. 4. The edges (404) connect the nodes (402) to other nodes (402). Edges (404) may connect, or not connect, to any node(s) (402) regardless of which layer (405) the node(s) (402) is in. That is, the nodes (402) may be sparsely and residually connected. For example, in a recurrent neural network (RNN), nodes (402) in the output layer (414) may be connected by edges (404) to nodes (402) in the input layer (408) (though not shown in FIG. 4).

A neural network (400) will have at least two layers (405), where the first layer (408) is the “input layer” and the last layer (414) is the “output layer.” Any intermediate layer (410, 412) is usually described as a “hidden layer.” A neural network (400) may have zero or more hidden layers (410, 412). A neural network (400) with at least one hidden layer (410, 412) may be described as a “deep” neural network or “deep learning method.” In general, a neural network (400) may have more than one node (402) in the output layer (414). In these cases, the neural network (400) may be referred to as a “multi-target” or “multi-output” network.

Nodes (402) and edges (404) carry associations. Namely, every edge (404) is associated with a numerical value. The edge numerical values, or even the edges (404) themselves, are often referred to as “weights” or “parameters.” While training a neural network (400), a process that will be described below, numerical values are assigned to each edge (404). Additionally, every node (402) is associated with a numerical value and may also be associated with an activation function. Activation functions are not limited to any functional class, but traditionally follow the form:

$$A = f ( {\sum }_{i ∈ ( incoming )} [ {( node value )}_{i} {( edge value )}_{i} ] ) , \qquad Equation ( 5 )$$

where i is an index that spans the set of “incoming” nodes (402) and edges (404) and f is a user-defined function. Incoming nodes (402) are those that, when viewed as a graph (as in FIG. 4), have directed arrows that point to the node (402) where the numerical value is being computed. Some functions ƒ may include the linear function ƒ(x)=x, sigmoid function

$$f ( x ) = \frac{1}{1 + {e}^{- x}} ,$$

and rectified linear unit function ƒ(x)=max(0,x), however, many additional functions are commonly employed. Every node (402) in a neural network (400) may have a different associated activation function. Often, as a shorthand, activation functions are described by the function ƒ by which it is composed. That is, an activation function composed of a linear function ƒ may simply be referred to as a linear activation function without undue ambiguity.

When the neural network (400) receives an input, the input is propagated through the network according to the activation functions and incoming node values and edge values to compute a value for each node (402). That is, the numerical value for each node (402) may change for each received input while the edge values remain unchanged. Occasionally, nodes (402) are assigned fixed numerical values, such as the value of 1. These fixed nodes (406) are not affected by the input or altered according to edge values and activation functions. Fixed nodes (406) are often referred to as “biases” or “bias nodes” as displayed in FIG. 4 with a dashed circle.

In some implementations, the neural network (400) may contain specialized layers (405), such as a normalization layer, pooling layer, or additional connection procedures, like concatenation. One skilled in the art will appreciate that these alterations do not exceed the scope of this disclosure.

As noted, the training procedure for the neural network (400) comprises assigning values to the edges (404). To begin training the edges (404) are assigned initial values. These values may be assigned randomly, assigned according to a prescribed distribution, assigned manually, or by some other assignment mechanism. Once edge (404) values have been initialized, the neural network (400) may act as a function, such that it may receive inputs and produce an output. As such, at least one input is propagated through the neural network (400) to produce an output. Generally, a training dataset is provided the neural network for training. The training dataset is composed of inputs and associated target(s), where the target(s) represent the “ground truth”, or the otherwise desired output. The neural network (400) output is compared to the associated input data target(s).

The comparison of the neural network (400) output to the target(s) is typically performed by a so-called “loss function”; although other names for this comparison function such as “error function” and “cost function” are commonly employed. Many types of loss functions are available, such as the mean-squared-error function, however, the general characteristic of a loss function is that the loss function provides a numerical evaluation of the similarity between the neural network (400) output and the associated target(s). In some embodiments, the loss function may be based, at least in part, on a KL divergence. In some embodiments, the training dataset, that includes a plurality of seismic patches (302), each having a labeled feature (208), may be used to generate the “target” or pixels in the seismic image (200) classified as belonging to the labeled feature (208). A candidate labeled feature patch (316) created by the neural network (400) in the reverse diffusion process (301) and may be used to determine the similarity of the predicted labeled features to the “targets”.

The loss function may also be constructed to impose additional constraints on the values assumed by the edges (404), for example, by adding a penalty term, which may be physics-based, or a regularization term. Generally, the goal of a training procedure is to alter the edge (404) values to promote similarity between the neural network (400) output and associated target(s) over the data set. Thus, the loss function is used to guide changes made to the edge (404) values, typically through a process called “backpropagation”.

While a full review of the backpropagation process exceeds the scope of this disclosure, a brief summary is provided. Backpropagation consists of computing the gradient of the loss function over the edge values. The gradient indicates the direction of change in the edge values that results in the greatest change to the loss function. Because the gradient is local to the current edge values, the edge values are typically updated by a “step” in the direction indicated by the gradient. The step size is often referred to as the “learning rate” and need not remain fixed during the training process. Additionally, the step size and direction may be informed by previous edge values or previously computed gradients. Such methods for determining the step direction are usually referred to as “momentum” based methods.

Once the edge (404) values have been updated, or altered from their initial values, through a backpropagation step, the neural network (400) will likely produce different outputs. Thus, the procedure of propagating at least one input through the neural network (400), comparing the neural network (400) output with the associated target(s) with a loss function, computing the gradient of the loss function with respect to the edge (404) values, and updating the edge (404) values with a step guided by the gradient, is repeated until a termination criterion is reached. Common termination criteria are reaching a fixed number of edge (404) updates, otherwise known as an iteration counter; a diminishing learning rate; noting no appreciable change in the loss function between iterations; reaching a specified performance metric as evaluated on the data or a separate hold-out dataset. Once the termination criterion is satisfied, and the edge (404) values are no longer intended to be altered, the neural network (400) is said to be “trained.”

With the ML network trained, it may now be used to detect features in a production seismic dataset in accordance with one or more embodiments. As described herein, a production seismic dataset may refer to any seismic dataset having unlabeled features. In some embodiments, the production seismic dataset may be a fully processed seismic dataset having previous seismic processes performed such as noise attenuation or migration. Migration refers to the process of creating a seismic image (200) from the seismic data, in which seismic reflectors are accurately positioned in their correct spatial locations, taking into account the effects of the velocity of the subsurface layers. In other embodiments, the production dataset may be a new seismic dataset, recently acquired using a seismic acquisition system (190) over a subterranean region of interest (100) or any other “raw” seismic datasets having little or no previous seismic processing performed including no noise attenuation processes. In other words, the production seismic dataset may be a noisy seismic dataset and the noise may mask the features.

Prior to the ML network being used to detect a feature on a production seismic dataset, the production seismic dataset may be partitioned into a plurality of production seismic patches using the seismic processing system. In some embodiments, a sliding overlap window may be used to partition or extract the plurality of production seismic patches. In these embodiments, a sliding overlap window is positioned on the production seismic dataset having a predefined size and overlap. The seismic data within the window is extracted for a production seismic patch. The window is then moved to a new location on the production seismic dataset by a set distance having a set overlap with the previous window to extract the next production seismic patch. The overlap is chosen to minimize edge effects in the data processing. By using a sliding overlap window to extract the seismic data, the production seismic patches may include overlapping production seismic patches in accordance with one or more embodiments.

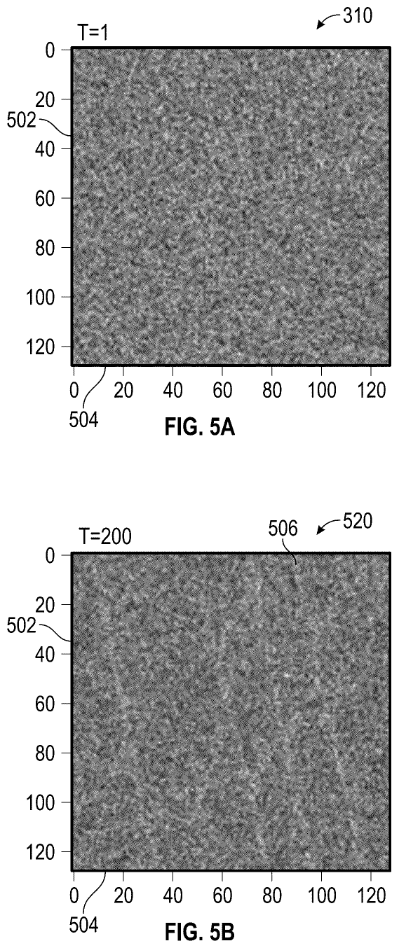

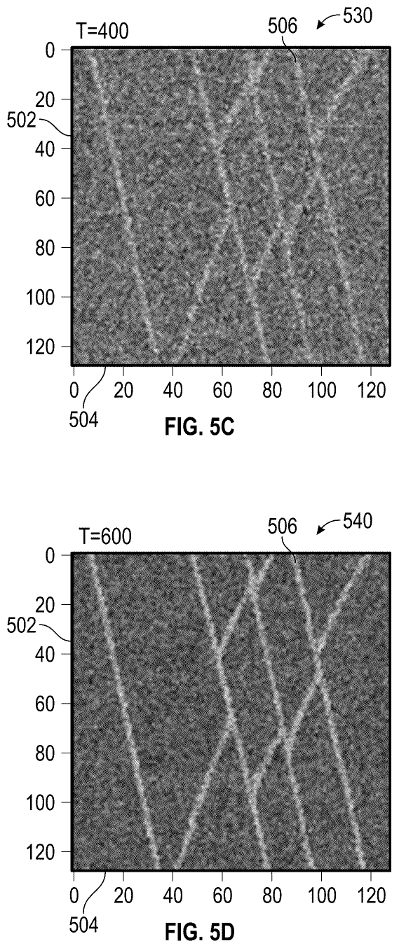

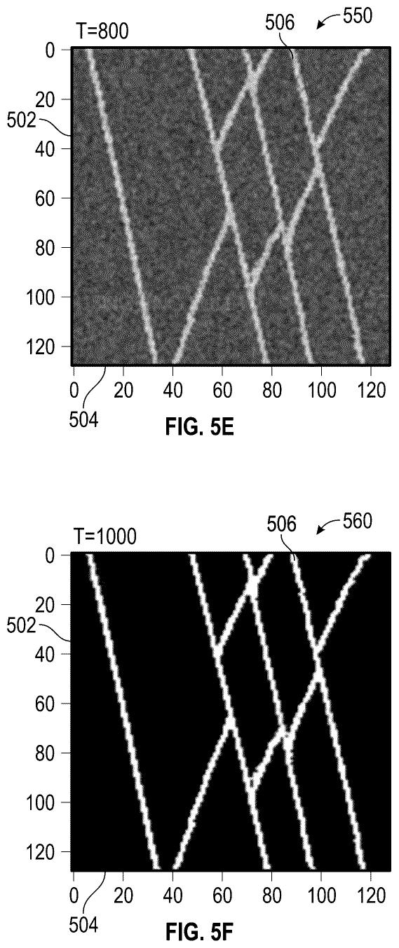

FIGS. 5A-5F illustrate a series of predicted labeled feature patches (510, 520, 530, 540, 550, 560) at 1, 200, 400, 600, 800 and 1000 iterations respectively. A predicted labeled feature patch (510, 520, 530, 540, 550, 560) describes the output of the trained DDPM and includes a labeled manifestation of the feature (506). Each patch displays a labeled manifestation of the feature (506) at increasing depths or two-way travel times indicated by the vertical axis (502) and the horizontal axis (504) represents the horizontal locations of the features. The predicted labeled feature patch (510, 520, 530, 540, 550, 560) may be a binary image in accordance with one or more embodiments, having a pixel value of either one or zero. Each pixel in the predicted labeled feature patch (510, 520, 530, 540, 550, 560) is labeled as being intersected by a feature, or not being intersected by a feature. In this case, the feature shown is a fault (120). The predicted labeled feature patches (510, 520, 530, 540, 550, 560) in FIG. 5F are shown having a pixel value of one in white indicating a fault (120) and a pixel value of zero in black indicating a non-fault.

The trained DDPM predicts a feature within the production seismic patch in a series of iterations, defined by the parameter T. In some embodiments the iterations may be a predetermined parameter, while in other embodiments the number of iterations may be defined by a solution convergence, or when the predicted feature solution stops changing or changes insignificantly after subsequent iterations. By observing the labeled manifestation of the feature (506) in each of the predicted labeled feature patches (510, 520, 530, 540, 550, 560) the feature becomes more coherent after increasing iterations, illustrating the denoising of the reverse diffusion process (301).

For example, in FIG. 5A after a single iteration of the DDPM prediction, the predicted labeled feature patch (510) is masked by a high level of noise and there is no observable feature labeled. In FIG. 5B, after 200 iterations, the predicted labeled feature patch (520) remains masked by a high level of noise and in FIG. 5C after 400 iterations, the predicted labeled feature patch (530) is denoised at a level where the predicted feature begins to become observable. In FIG. 5D, after 600 iterations of the DDPM prediction, the predicted labeled feature patch (540) shows more coherent labeled manifestations of the feature (506) and in FIG. 5E after 800 iterations, the predicted labeled feature patch (550) shows progressively more coherent labeled manifestations of the feature (506) with a reduced amount of noise still included in the predicted labeled feature patch (550). Finally, FIG. 5F shows a predicted labeled feature patch (560) which is the output from 1000 iterations of the trained DDPM and includes much more coherent labeled manifestations of the feature (506) with no noise or a greatly reduced amount of noise included within the predicted labeled feature patch (560). The final iteration is determined by a maximum predefined number or iterations, or by a solution convergence.

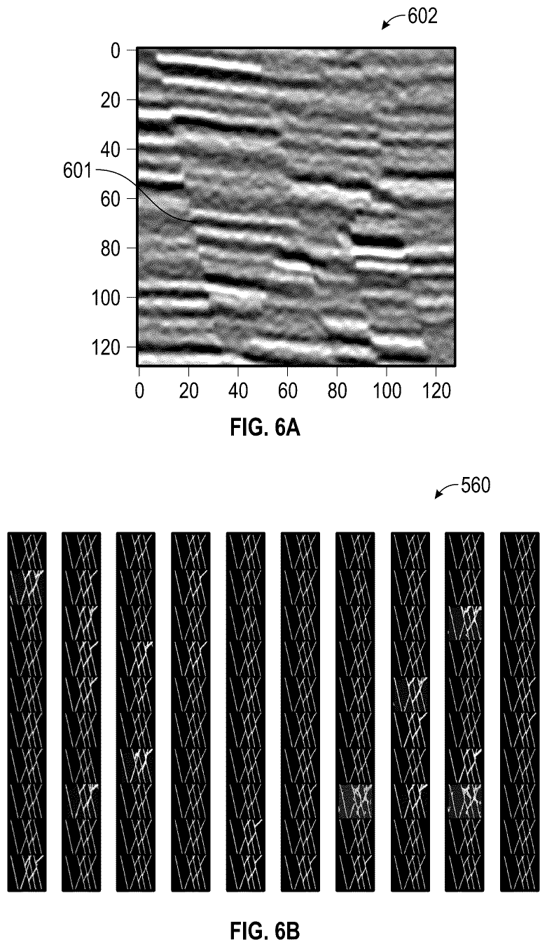

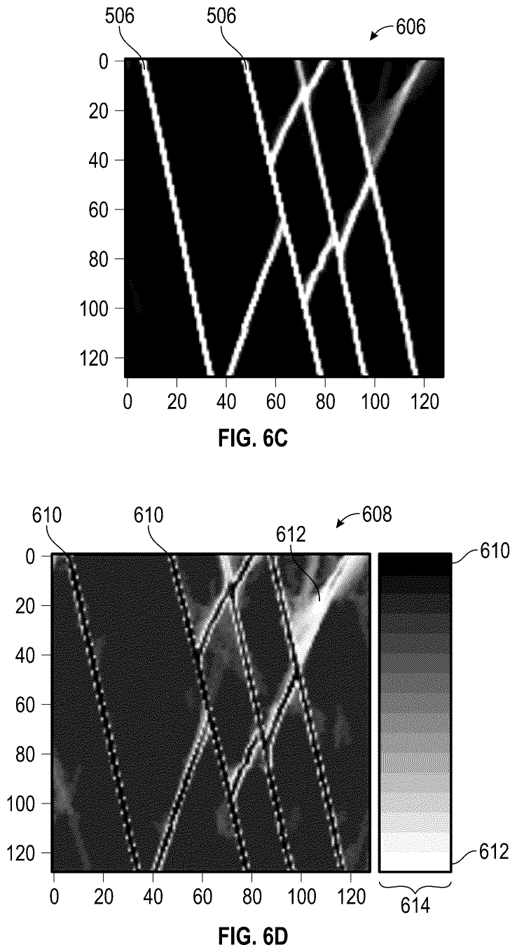

The trained DDPM is stochastic, therefore using the trained DDPM for a set number of iterations multiple times on the same input production seismic patch may result in a different predicted labeled feature patch (560) each time. For a final solution to predict a feature on a production seismic patch, the trained DDPM may be used to generate a predefined number of outputs and the mean value may be used as the final predicted labeled feature patch (560). Furthermore, stochastic processes are random processes and may be subject to uncertainty. An uncertainty analysis may be performed on each predicted labeled feature patch (560) and is discussed further in FIG. 6D.

FIG. 5F illustrates a single predicted labeled feature patch (560) created from a trained DDPM. The predicted labeled feature patch (560) may be the mean value of a predetermined number of outputs in accordance with one or more embodiments. Each one of the production seismic patches may be input into the trained DDPM a predetermined number of times, to generate a plurality of predicted labeled feature patches (560). Each of the plurality of predicted labeled feature patches (560) includes a labeled manifestation of the feature (506) from a separate location within the production seismic dataset and contains overlap. Once each of the plurality of production seismic patches have been input into the trained DDPM and a plurality of predicted labeled feature patches (560) have been generated, a predicted labeled feature image may be formed in accordance with one or more embodiments. The predicted labeled feature image may be created by merging the overlap of the predicted labeled feature patches (560). The predicted labeled feature image which includes a labeled manifestation of the feature (506) may be extracted onto the production seismic dataset to label the feature on the production seismic dataset in accordance with one or more embodiments.

FIG. 6A illustrates a production seismic patch (602) in accordance with one or more embodiments. The production seismic patch (602) having unlabeled features (601), may be input into a trained DDPM to predict the features in accordance with one or more embodiments. A single production seismic patch (602) may be input to the DDPM a predetermined number of times to produce a predetermined number of predictions or predicted labeled feature patches (560), shown in FIG. 6B. FIG. 6B illustrates one hundred outputs from the trained DDPM, from a single production seismic patch (602). The predicted labeled feature patches (560) include a labeled manifestation of the feature (white lines), in this case a fault (120).

Using the one hundred predicted labeled feature patches (560), the final feature prediction, or in this case fault prediction may be determined by determining the mean value. The mean value may be calculated by

$$\hat{y} = \frac{1}{N} {\sum }_{i} {y}_{i} ,$$

where N is the predetermined number of predicted labeled feature patches (560) and in this case one hundred, and y is the value of the pixel at each pixel location. In some embodiments, the final feature prediction may be determined by the median value or the maximum value from the predicted labeled feature patches (560). Any statistical computation from the plurality of predicted labeled feature patches (560) may be used to determine the final feature prediction without departing from the scope of the method. FIG. 6C displays the mean value feature prediction (606), calculating using the one hundred predicted labeled feature patches (560). The mean value feature prediction (606) may represent the most reliable and robust estimate of the feature. FIG. 6C illustrates the labeled manifestation of the feature (506). In some embodiments, the mean value feature prediction (606) may be selected as the final output from the DDPM. In some embodiments, the predicted labeled feature patches (560) may be analyzed to remove any anomalous outputs prior to determining the mean value feature prediction (606).

The DDPM produces probabilistic outputs and therefore, an uncertainty analysis (608) may be performed on the predicted labeled feature patches (604) using

$$Δ y = \sqrt{\frac{1}{N} {\sum }_{i} {( {y}_{i} - \hat{y} )}^{2}} .$$

The uncertainty analysis (608) of the predicted features is illustrated in FIG. 6D and may be used by seismic interpreters to evaluate the uncertainty of the detected features. The pixel values of the uncertainty analysis (608) are defined by the color bar (614) and give the standard deviation value at each pixel. The pixels having the darkest black color (610) represent the lowest standard deviation values, providing the highest confidence in the prediction and the pixels having a white color (612) represent the largest standard deviation values which indicate a lower confidence in those predicted pixels. FIG. 6D illustrates an uncertainty analysis (608) by calculating the standard deviation at each pixel, however any other technique to perform an uncertainty analysis (608) may be performed including determining a variance map or performing a Monte Carlo simulation. Note that the present disclosure should in no way be limited based on the type of uncertainty analysis performed.

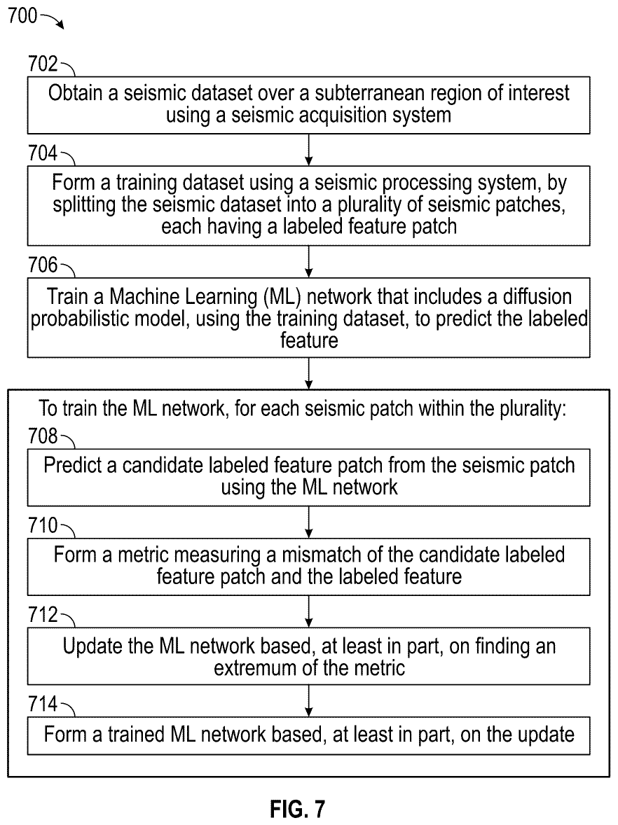

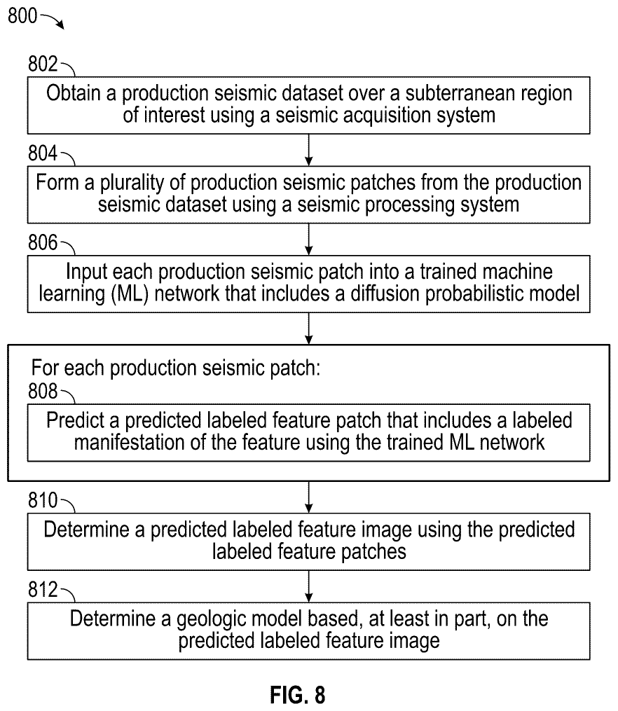

FIG. 7 describes a method (700) in accordance with one or more embodiments. The method (700) describes training a ML network to label a feature in a seismic dataset in accordance with one or more embodiments. The seismic dataset is split into a plurality of seismic patches (302) having a labeled feature (208) and is used to train a ML network to predict a candidate labeled feature patch (316). The candidate labeled feature patch (316) is compared to the labeled features (208) and a metric measuring the mismatch is formed. The ML network is updated based on finding an extremum of the metric to form a trained ML network. Once trained, the ML network may be used on unlabeled datasets to label a feature, which is described in the method (800) described in FIG. 8.

While the methods (700,800) below describe a method of training a ML network and a method of using the trained ML network, these methods may be performed independently without departing from the scope of the disclosure. The methods (700, 800) may be used to ultimately determine a predicted labeled feature image to determine a drilling target (145) within the subterranean region of interest (100).

In Step 702, a seismic dataset over a subterranean region of interest (100) is obtained using a seismic acquisition system (190). In some embodiments, multiple seismic datasets may be obtained from several different subterranean regions of interest (100) to train the ML network. The seismic dataset may include a plurality of seismic images (200) having a labeled feature (208). Any other geologic data having a labeled feature (208) other than seismic data may be obtained and used to train the ML network without departing from the scope of the method (700).

In Step 704, a training dataset is formed, using a seismic processing system, by splitting the seismic dataset into a plurality of seismic patches (302). Each seismic patch (302) includes a labeled feature (208). In some embodiments, the feature may include a fault (120). In other embodiments, the feature may also include horizons (110), facies, hydrocarbon reservoirs (115) and weakness zones (155). While the present disclosure focuses on fault detection, the method should in no way be limited based on the type of structure or characteristic of the feature.

In Step 706, a ML network is trained, using the training dataset, to predict the labeled feature (208). In some embodiments, the ML network includes a diffusion probabilistic model (DPM). The DPM may include a denoising diffusion probabilistic model (DDPM). The DDPM may include a forward diffusion process (300) and a reverse diffusion process (301) as described by FIGS. 3A and 3B. The following Steps 708-714 expands on Step 706 and describes training the ML network in greater detail. Steps 708-712 are performed for each of the plurality of seismic patches (302) included in the training dataset to train the ML network. In Step 708, a candidate labeled feature patch (316) is predicted from the seismic patch (302) using the ML network. Predicting the candidate labeled feature patch (316) includes generating a random noise patch (310) by adding random noise to the seismic patch, generating a loss function to fit the random noise patch, and predicting the candidate labeled feature patch (316) based, at least in part, on denoising the random noise patch (310) to minimize the loss function.

The random noise is added to the input seismic patch (302) in a forward diffusion process (300) until the patch becomes fully random with noise, referred to as the random noise patch (310). In some embodiments, the random noise may be a Gaussian noise. The DDPM learns the probability distributions of moving to each subsequent state of added noise in the forward diffusion process (300). Then in a reverse diffusion process (301), a neural network (400) may be trained to generate data by converting the fully random noise patch (310) into realistic data, or denoising the random noise patch (310) until it resembles the original input seismic patch (302). The reverse diffusion process (301) may generate a best fit of the added noise in the form of a loss function. In some embodiments, the loss function is based, at least in part, on a Kullback-Leibler (KL) divergence and the candidate labeled feature patch (316) may be predicted based on denoising the random noise patch (310) to minimize the loss function.

In Step 710, a metric is formed, measuring a mismatch of the candidate labeled feature patch (316) and the labeled feature (208). The metric may be a predefined accuracy metric that gives an allowable mismatch criterion for a successful prediction. In some embodiments, this metric may be formed by performing an uncertainty analysis, including generating a variance map. In other embodiments, the metric may be measured by a benchmark percentage of total features successfully identified, or total number of pixels within the seismic image successfully identified.

In Step 712, the ML network is updated based, at least in part, on finding an extremum of the metric. The DDPM will determine the input parameters of the model that would minimize the mismatch between the labeled features (208) and the predicted features and subsequently update the DDPM to incorporate the new parameters. The DDPM may be trained on several seismic patches (302) from a training dataset. The training dataset may also include several separate seismic datasets from multiple regions, each having unique feature characteristics that are labeled in the inputs. The DDPM may be sufficiently trained when the model parameters converge to a solution and the uncertainty analysis consistently meets an approved acceptance criterion.

The method (700) described above includes training a ML network to predict a labeled feature patch (316) from a training dataset. Once trained, this ML network may be applied on a new seismic dataset having unlabeled features (601), to create a predicted labeled feature image and is described in FIG. 8. The types of features used to train the ML network should be consistent with the types of features attempting to be identified in method (800) below.

In Step 802, a production seismic dataset over a subterranean region of interest (100) is obtained using a seismic acquisition system (190). A production seismic dataset may be any geologic dataset having unlabeled features (601) including raw or fully processed seismic datasets. In Step 804, a plurality of production seismic patches (602) is formed, using a seismic processing system. The plurality of production seismic patches (602) may include overlapping production seismic patches formed by using a sliding overlap window to extract the data from the production seismic dataset.

In Step 806, each production seismic patch (602) is input into a trained ML network. The ML network has been trained according to method (700) to identify the unlabeled features (601) in the production seismic patches (602). The feature may include a fault (120) in accordance with one or more embodiments and should be consistent with the feature used to train the ML network. In some embodiments, the ML network includes a diffusion probabilistic model (DPM). Specifically, the DPM may include a denoising diffusion probabilistic model or DDPM.

In Step 808, a predicted labeled feature patch (560), which includes a labeled manifestation of the feature (506), is predicted using the trained ML network. The trained DDPM predicts a feature within the production seismic patch (602), in a series of iterations. In some embodiments, the iterations may be a predetermined maximum set number, or defined by a solution convergence. The trained DDPM is stochastic, therefore using the trained DDPM for a set number of iterations multiple times on the same input production seismic patch (602) may result in a different predicted labeled feature patch (560) each time. For a final solution to predict a feature on a production seismic patch (602), the trained DDPM may be used to generate a predefined number of outputs or predicted labeled feature patches (560) and the mean value feature prediction (606) may be used as the final predicted labeled feature patch (560) having the labeled manifestation of the feature (506). A final predicted labeled feature patch (560) may be predicted for each one of the plurality of production seismic patches (602).

In Step 810, a predicted labeled feature image is created using the predicted labeled feature patches (560). In Step 804, the plurality of production seismic patches (602) was described as including overlap by using a sliding overlap window to extract the data. Therefore, each predicted labeled feature patch (560) includes the same overlap. Creating the predicted labeled feature image may include merging this overlap of the predicted labeled feature patches (560). The predicted labeled feature image includes the entirety of production seismic data now having a labeled manifestation of a feature (506).

Using a DDPM for feature detection addresses two major limitations of using more traditional ML techniques to predict features in seismic data which are the inability to incorporate geologic prior information into the ML network and an inability to perform an uncertainty analysis (608) of the detected features. The DDPM incorporates geologic prior information by using input seismic patches (302) having labeled features (208). Furthermore, the DDPM produces probabilistic outputs and therefore, an uncertainty analysis (608) may be performed on the predicted labeled feature image or each of the predicted labeled feature patches (560). The uncertainty analysis (608) allows for seismic interpreters to evaluate the confidence in each predicted feature. Furthermore, by evaluating an uncertainty analysis (608) of a predicted feature such as a fault (120), seismic interpreters may develop a better understanding of the limitations of the seismic data. Areas in the predicted labeled feature image that include a high uncertainty may indicate further seismic processing is necessary to improving imaging of that area. Uncertainty analysis (608) may also aid in determining risk assessments for drilling around areas of high uncertainty.

In Step 812, a geologic model may be determined based, at least in part, on the predicted labeled feature image. Geologic models may also include, geophysical models, and/or geomechanical models (hereinafter “models”) that models the subterranean region of interest (100). As such, the models may then include the location and size of features labeled within the predicted labeled feature image. In turn, the models may be used to aid in the planning of a wellbore path (150). The models may also be used, at least in part, to plan injection wellbore paths and infill wellbore paths within the subterranean region of interest (100) among other activities.

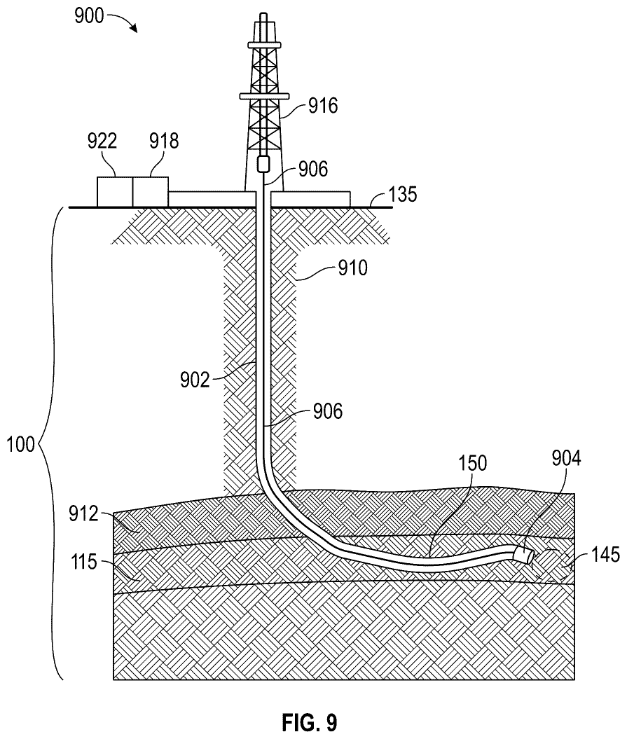

In some embodiments, the predicted labeled feature image may also be used separately from models to identify a location and size of a drilling target (145) within the hydrocarbon reservoir (115) within the subterranean region of interest (100). As previously described, the drilling target (145) may be a compartment (140) within the hydrocarbon reservoir (115) that often contains hydrocarbons. The drilling target (145) may be identified based on the labeled manifestations of the feature (506) within the predicted labeled feature image and other information associated with hydrocarbon flow, such as permeability. In some embodiments, an interpreter may manually identify the location and size of the drilling target (145) using a seismic interpretation workstation, as described in reference to FIG. 9.

Following the identification of the location and size of the drilling target (145) using the predicted labeled feature image, a wellbore path (150) may be planned, using a wellbore planning system, to intersect the drilling target (145). The wellbore plan may be additionally informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes. A wellbore may be drilled guided by the wellbore path (150) using a drilling system.

FIG. 9 depicts a drilling system (900) in accordance with one or more embodiments. As shown in FIG. 9 a wellbore (902) may be drilled by a drill bit (904) attached by a drillstring (906) to a drill rig (916) located on the surface of the earth (135). The well may traverse a plurality of overburden layers (910) and one or more cap-rock layers (912) to a drilling target (145) within a hydrocarbon reservoir (115). In accordance with one or more embodiments, the predicted labeled feature image may be used to plan a wellbore path (150) and drill a wellbore (902) guided by the wellbore path (150). The wellbore path (150) may be a curved well path, or a straight well path. All or part of the wellbore path (150) may be vertical, and some well paths may deviate or have horizontal sections.

Prior to the commencement of planning a wellbore, the predicted labeled feature image may be interpreted using the seismic interpretation workstation (922) to determine a drilling target (145) based, at least in part, on the predicted labeled feature image. Seismic interpretation may include manual steps, such as “picking” a sparse set of points on a single interpreted undulating geological boundary, and automatic or algorithmic steps, such as picking all the remaining grid points, intervening between the manually picked points, lying on the boundary using the manually picked points as a guide or “seeds”. In the past, such interpretation was performed using displays of portions of the seismic image printed on paper with the interpretation drawn, originally hand-drawn, on the paper using colored pen or pencils. Now, a seismic interpreter of ordinary skill in the art will, almost without exception, use a seismic interpretation workstation (922) to perform seismic interpretation.

A seismic interpretation workstation (922) may include one or more computer processors and a computer-readable memory containing instructions executable by the processor. The computer memory may further contain seismic images (200) and/or seismic attributes. The seismic interpretation workstation (922) may include a software platform configured to accept multiple types of data including well logs, seismic images (200), seismic velocity models and geological models. The software platform may aggregate the data from these systems to determine the subsurface location of a drilling target (145).

The seismic interpretation workstation (922) may also include a display mechanism, usually one or more monitor screens, but sometimes one or more projector, user-wearable goggles or other virtual reality display equipment and a means of interacting with the display, such as a computer mouse or wand. Further, the seismic interpretation workstation (922) may include dedicated hardware designed to expedite the rendering and display of the seismic image, images, or attributes in a manner and at a speed to facilitate real-time interaction between the user and the data. For example, the seismic interpretation workstation (922) may allow the seismic interpreter to scroll through adjacent slices through a 3D seismic image to visually track the continuity of a candidate geological boundary throughout the 3D image. Alternatively, the seismic interpretation workstation (922) may allow the seismic interpreter to manually control the rotation of the view angle of the seismic image so it may be viewed from above, or from the East or from the West, or from intermediate directions.

As for the seismic interpretation system, the computer processor or processors and computer memory of the seismic interpretation workstation (922) may be co-located with the seismic interpreter, while in other cases the computer processor and memory may be remotely located from the seismic interpreter, such as on “the cloud.” In the latter case, the seismic or attribute images may only be displayed on a screen, including a laptop or tablet local to the seismic interpreter, who may interact with the computer processor via instructions sent over a network, including a secure network such as a virtual private network (VPN).

Once a drilling target (145) has been determined from the seismic interpretation and prior to the commencement of drilling, a wellbore plan may be generated using a wellbore planning system (918). The wellbore plan may include a starting surface location of the wellbore, or a subsurface location within an existing wellbore, from which the wellbore (902) may be drilled. Further, the wellbore plan may include a terminal location that may intersect with the targeted hydrocarbon bearing formation and a planned wellbore path (150) from the starting location to the terminal location. In other words, the wellbore path (150) may intersect a previously located hydrocarbon reservoir (115).

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Furthermore, the wellbore plan may consider other engineering constraints such as the maximum wellbore curvature (“dog-log”) that the drillstring (906) may tolerate and the maximum torque and drag values that the drilling system (900) may tolerate.

In some embodiments, a wellbore planning system (918) may be used to generate the wellbore plan based on the drilling target (145) and an advantageous wellbore path (150) to the drilling target (145) to extract hydrocarbons. While the seismic interpretation workstation (922) and the wellbore planning system (918) are shown at the drilling location, in some embodiments, the seismic interpretation workstation (922) and the wellbore planning system (918) may be remote from a well site.

The wellbore planning system (918) may comprise one or more computer processors in communication with computer memory containing geophysical and geomechanical models, information relating to drilling hazards, and the constraints imposed by the limitations of the drillstring (906) and the drilling system (900). The wellbore planning system (918) may further include dedicated software to determine the planned wellbore path (150) and associated drilling parameters, such as the planned wellbore diameter, the location of planned changes of the wellbore diameter, the planned depths at which casing will be inserted to support the wellbore and to prevent formation fluids entering the wellbore, and the drilling mud weights (densities) and types that may be used during drilling the wellbore (902).

A wellbore (902) may be drilled using a drill rig (916) that may be situated on a land drill site, an offshore platform, such as a jack-up rig, a semi-submersible, or a drill ship. The drill rig (916) may be equipped with a hoisting system, which can raise or lower the drillstring (906) and other tools required to drill the well. The drillstring (906) may include one or more drill pipes connected to form conduit and a bottom hole assembly (BHA) disposed at the distal end of the drillstring (906). The BHA may include a drill bit (904) to cut into subsurface rock. The BHA may further include measurement tools, such as a measurement-while-drilling (MWD) tool and logging-while-drilling (LWD) tool. MWD tools may include sensors and hardware to measure downhole drilling parameters, such as the azimuth and inclination of the drill bit, the weight-on-bit, and the torque. The LWD measurements may include sensors, such as resistivity, gamma ray, and neutron density sensors, to characterize the rock formation surrounding the wellbore. Both MWD and LWD measurements may be transmitted to the surface of the earth (135) using any suitable telemetry system, such as mud-pulse or wired-drill pipe, known in the art.

To start drilling, or “spudding in” the well, the hoisting system lowers the drillstring (906) suspended from the drill rig (916) towards the planned surface location of the wellbore (902). An engine, such as a diesel engine, may be used to rotate the drillstring (906). The weight of the drillstring (906) combined with the rotational motion enables the drill bit (904) to bore the wellbore.

The near-surface is typically made up of loose or soft sediment or rock, so large diameter casing, e.g. “base pipe” or “conductor casing,” is often put in place while drilling to stabilize and isolate the wellbore (902). At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface of the earth (135).

Drilling may continue without any casing once deeper more compact rock is reached. While drilling, drilling mud may be injected from the surface of the earth (135) through the drill pipe. Drilling mud serves various purposes, including pressure equalization, removal of rock cuttings, or drill bit cooling and lubrication. At planned depth intervals, drilling may be paused and the drillstring (906) withdrawn from the wellbore (902). Sections of casing may be connected and inserted and cemented into the wellbore (902). Casing string may be cemented in place by pumping cement and mud, separated by a “cementing plug,” from the surface (135) through the drill pipe. The cementing plug and drilling mud force the cement through the drill pipe and into the annular space between the casing and the wellbore wall. Once the cement cures drilling may recommence. The drilling process is often performed in several stages. Therefore, the drilling and casing cycle may be repeated more than once, depending on the depth of the wellbore and the pressure on the wellbore walls from surrounding rock. Due to the high pressures experienced by deep wellbores, a blowout preventer (BOP) may be installed at the wellhead to protect the rig and environment from unplanned oil or gas releases. As the wellbore (902) becomes deeper, both successively smaller drill bits and casing string may be used. Drilling deviated or horizontal wellbores may require specialized drill bits or drill assemblies.

A drilling system (900) may be disposed at and communicate with other systems in the well environment. The drilling system (900) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure WOB (weight on bit), RPM (drill rotational speed), GPM (flow rate of the mud pumps), and ROP (rate of penetration of the drilling operation). Each sensor may be positioned or configured to measure a desired physical stimulus. Drilling may be considered complete when a drilling target (145) is reached, or the presence of hydrocarbons is established.

FIG. 10 illustrates a computer system (1005) in accordance with one or more embodiments. The computer (1005) may be specifically configured for seismic processing and denoted a “seismic processing system.” For example, the method described in FIG. 7 or 8 may be performed on a seismic processing system.

Alternatively, the computer (1005) may be specifically configured for seismic interpretation and denoted a “seismic interpretation workstation (922).” For example, identifying the drilling target (145) within the hydrocarbon reservoir (115) using the predicted labeled feature image may be performed, at least in part, using a seismic interpretation workstation (922). While the generic term computer (1005) may be used to describe the parts of a computer (1005) in the following paragraphs, the terms seismic processing system or seismic interpretation workstation (922) may replace the term computer (1005) without departing from the scope of the disclosure.

The computer (1005) is intended to depict any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1005) may include an input device, such as a keypad, keyboard, touch screen, or other device that can accept user information, and an output device that displays information, including digital data, visual or audio information (or a combination of both), or a graphical user interface. Specifically, a seismic interpretation workstation (922) may include a robust graphics card for the detailed rendering of the production seismic patches (602), predicted labeled feature patches (560) and/or predicted labeled feature images, such that the images(s) may be displayed and manipulated in a virtual reality system using 3D goggles, a mouse, or a wand. In turn, each production seismic patch (602) may be manipulated to determine the associated predicted labeled feature patch (560). Further, the predicted labeled feature image may be manipulated to identify the drilling target (145) within the hydrocarbon reservoir (115) and possibly drilling hazards within the subterranean region of interest (100).

The computer (1005) can serve in a role as a client, network component, server, database, or any other component (or a combination of roles) of a computer system (1005) as required for seismic processing and seismic interpretation. The illustrated computer system (1005) is communicably coupled with a network (1010). For example, a seismic processing system and a seismic interpretation workstation (922) may be communicably coupled using a network (1010). In some implementations, one or more components of each computer system (1005) may be configured to operate within environments, including cloud-computing-based, local, global, or other environment (or a combination of environments).

At a high level, the computer system (1005) is an electronic computing device operable to receive, transmit, process, store, and/or manage data and information associated with seismic processing and seismic interpretation. According to some implementations, the computer system (1005) may also include or be communicably coupled with an application server, e-mail server, web server, caching server, streaming data server, business intelligence (BI) server, or other server (or a combination of servers).

Because seismic processing and seismic interpretation may not be sequential, the computer system (1005) can receive requests over network (1010) from other computer systems (1005) or another client application and respond to the received requests by processing the requests appropriately. In addition, requests may also be sent to the computer system (1005) from internal users (for example, from a command console or by other appropriate access method), external or third-parties, other automated applications, as well as any other appropriate entities, individuals, systems, or computer systems (1005).

Each of the components of the computer system (1005) can communicate using a system bus (1015). In some implementations, any or all of the components of each computer system (1005), both hardware or software (or a combination of hardware and software), may interface with each other or the interface (1020) (or a combination of both) over the system bus (1015) using an application programming interface (API) (1012) or a service layer (1030) (or a combination of the API (1025) and service layer (1030). The API (1025) may include specifications for routines, data structures, and object classes. The API (1025) may be either computer-language independent or dependent and refer to a complete interface, a single function, or even a set of APIs. The service layer (1030) provides software services to each computer system (1005) or other components (whether or not illustrated) that are communicably coupled to each computer system (1005). The functionality of each computer system (1005) may be accessible for all service consumers using this service layer (1030). Software services, such as those provided by the service layer (1030), provide reusable, defined business functionalities through a defined interface. For example, the interface may be software written in JAVA, C++, or other suitable language providing data in extensible markup language (XML) format or another suitable format. While illustrated as an integrated component of each computer system (1005), alternative implementations may illustrate the API (1025) or the service layer (1030) as stand-alone components in relation to other components of each computer system (1005) or other components (whether or not illustrated) that are communicably coupled to each computer system (1005). Moreover, any or all parts of the API (1025) or the service layer (1030) may be implemented as child or sub-modules of another software module, enterprise application, or hardware module without departing from the scope of this disclosure.

The computer system (1005) includes an interface (1020). Although illustrated as a single interface (1020) in FIG. 10, two or more interfaces (1020) may be used according to particular needs, desires, or particular implementations of each computer system (1005). The interface (1020) is used by each computer system (1005) for communicating with other systems in a distributed environment that are connected to the network (1010). Generally, the interface (1020) includes logic encoded in software or hardware (or a combination of software and hardware) and operable to communicate with the network (1010). More specifically, the interface (1020) may include software supporting one or more communication protocols associated with communications such that the network (1010) or interface's hardware is operable to communicate physical signals within and outside of the illustrated computer (1005).

The computer system (1005) includes at least one computer processor (1035). Generally, a computer processor (1035) executes any instructions, algorithms, methods, functions, processes, flows, and procedures as described above. A computer processor (1035) may be a central processing unit (CPU) and/or a graphics processing unit (GPU). Seismic data used to determine the seismic image (200) and/or the predicted labeled feature image may be hundreds of terabytes in size. To efficiently process the seismic data and determine the seismic image (200) and/or the predicted labeled feature image, a seismic processing system may consist of an array of CPUs with one or more subarrays of GPUs attached to each CPU. Further, tape readers or high-capacity hard-drives may be connected to the CPUs using wide-band system buses (1015).

The computer system (1005) also includes a memory (1040) that stores data and software for the computer system (1005) or other components (or a combination of both) that can be connected to the network (1010). For example, the memory (1040) may store the wellbore planning system (918) in the form of software. Although illustrated as a single memory (1040) in FIG. 10, two or more memories may be used according to particular needs, desires, or particular implementations of the computer system (1005) and the described functionality. While memory (1040) is illustrated as an integral component of each computer system (1005), in alternative implementations, memory (1040) can be external to each computer system (1005).

The application (1045) is an algorithmic software engine providing functionality according to particular needs, desires, or particular implementations of the computer system (1005), particularly with respect to functionality described in this disclosure. For example, application (1045) can serve as one or more components, modules, applications, etc. Further, although illustrated as a single application (1045), the application (1045) may be implemented as multiple applications (1045) on each computer system (1005). In addition, although illustrated as integral to each computer system (1005), in alternative implementations, the application (1045) can be external to each computer system (1005).

There may be any number of computers (1005) associated with, or external to, a seismic processing system and a seismic interpretation workstation (918), where each computer system (1005) communicates over network (1010). Further, the term “client,” “user,” and other appropriate terminology may be used interchangeably as appropriate without departing from the scope of this disclosure. Moreover, this disclosure contemplates that many users may use the computer system (1005), or that one user may use multiple computer systems (1005).

The production seismic dataset, the training dataset, the plurality of seismic patches (302), the plurality of production seismic patches (602), the candidate labeled feature patches (316), the predicted labeled feature patches (560), and the predicted labeled feature image, as well as other geological data may be input into, stored on, and processed using the seismic processing system. Further, the seismic processing system may be used to perform the methods described in the present disclosure to train the ML network, determine a predicted labeled feature image.

The predicted labeled feature image may be transferred to and stored on the seismic interpretation workstation (via the network 1010 as described relative to FIG. 10). The predicted feature image may then be displayed on the seismic interpretation workstation (922). The predicted labeled feature image may display the labeled manifestations of the feature (506) within the subterranean region of interest (100). A seismic interpreter may then manually manipulate the predicted labeled feature image using the seismic interpretation workstation (922) to identify and label a drilling target (145) within the hydrocarbon reservoir (115) within the subterranean region of interest (100).

The predicted labeled feature image may then be loaded into the wellbore planning system (918) that may be located on a memory (1040) of a computer (1005). A user of the computer (1005) may use the predicted labeled feature image loaded into the wellbore planning system (918) to plan a wellbore path (150) that penetrates the hydrocarbon reservoir (115).

The planned wellbore path (150) may be loaded into the drilling system (900) discussed in reference to FIG. 9. The drilling system (900) may be configured to drill a wellbore (902) within the subterranean region of interest (100) guided by the planned wellbore path (150). Following drilling and completion of the wellbore (902), the wellbore (902) may be used to produce hydrocarbons from the hydrocarbon reservoir (115) to the surface of the earth (135).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method of training a machine learning (ML) network to label a feature in a seismic dataset comprising:
obtaining, using a seismic acquisition system, the seismic dataset over a subterranean region of interest;
forming, using a seismic processing system, a training dataset by splitting the seismic dataset into a plurality of seismic patches, each comprising a labeled feature;
training, using the training dataset, the ML network to predict the labeled feature, wherein the ML network comprises a diffusion probabilistic model and training comprises:
for each seismic patch within the plurality:
predicting, using the ML network, a candidate labeled feature patch from the seismic patch,
forming a metric measuring a mismatch of the candidate labeled feature patch and the labeled feature,
updating the ML network based, at least in part, on finding an extremum of the metric, and
forming a trained ML network based, at least in part, on the update.

2. The method of claim 1, wherein the feature comprises a fault.

3. The method of claim 1, wherein the diffusion probabilistic model comprises a denoising diffusion probabilistic model.

4. The method of claim 1, wherein predicting the candidate labeled feature patch further comprises:
generating a random noise patch by adding a random noise to the seismic patch;
generating a loss function to fit the random noise patch; and
predicting the candidate labeled feature patch based, at least in part, on denoising the random noise patch to minimize the loss function.

5. The method of claim 4, wherein the loss function is based, at least in part, on a Kullback-Leibler (KL) divergence.

6. A method of determining a predicted labeled feature image comprising:
obtaining, using a seismic acquisition system, a production seismic dataset over a subterranean region of interest;
forming, using a seismic processing system, a plurality of production seismic patches from the production seismic dataset;
inputting each production seismic patch into a trained ML network, wherein the trained ML network comprises a diffusion probabilistic model;
for each production seismic patch:
predicting a predicted labeled feature patch using the trained ML network, wherein the predicted labeled feature patch comprises a labeled manifestation of a feature; and
determining the predicted labeled feature image using the predicted labeled feature patches.

7. The method of claim 6, further comprising determining an uncertainty of the predicted labeled feature image.

8. The method of claim 6, wherein the plurality of production seismic patches comprises overlapping production seismic patches.

9. The method of claim 6, wherein the feature is a fault.

10. The method of claim 6, wherein creating the predicted labeled feature image further comprises merging an overlap of the predicted labeled feature patches.

11. The method of claim 6, wherein the diffusion probabilistic model comprises a denoising diffusion probabilistic model.

12. The method of claim 6, further comprising:
identifying, using a seismic interpretation workstation, a drilling target within the subterranean region of interest based, at least in part, on the predicted labeled feature image;
planning, using a wellbore planning system, a wellbore path based, at least in part, on the drilling target; and
drilling, using a drilling system, a wellbore guided by the wellbore path.

13. A system to label a feature in a production seismic dataset, comprising:
a seismic acquisition system configured to obtain the production seismic dataset from a subterranean region of interest;
a seismic processing system, configured to:
receive the production seismic dataset, and
form a plurality of production seismic patches; and
a trained ML network, configured to receive each production seismic patch and create a predicted labeled feature image, wherein the ML network comprises a diffusion probabilistic model.

14. The system of claim 13, further comprising a seismic interpretation workstation, configured to identify a drilling target within the subterranean region of interest based, at least in part, on the predicted labeled feature image.

15. The system of claim 14, further comprising:
a wellbore planning system configured to plan a wellbore path based, at least in part, on the drilling target, and
a drilling system configured to drill a wellbore guided by the wellbore path.

16. The system of claim 13, wherein the predicted labeled feature image comprises a labeled manifestation of the feature and wherein the feature comprises a fault.

17. The system of claim 13, wherein the diffusion probabilistic model comprises a denoising diffusion probabilistic model.

18. The system of claim 13, wherein the plurality of production seismic patches comprises overlapping production seismic patches.

19. The system of claim 13, wherein, the trained ML network, when creating the predicted labeled feature image, is configured to:
for each production seismic patch:
generate a random noise patch by adding a random noise to the production seismic patch,
generate a loss function to fit the random noise,
denoise the random noise patch based, at least part, on the loss function, to predict the feature,
output a predicted labeled feature patch based, at least in part, on the feature, and
create the predicted labeled feature image using the predicted labeled feature patches.

20. The system of claim 19, wherein creating the predicted labeled feature image further comprises merging an overlap of the predicted labeled feature patches.
